(19) United States
(12) Patent Application Publication
(10) Pub. No.: US 2018/0165401 A1
(43) Pub. Date: Jun. 14, 2018

(54) NON-ORTHOGONAL ROUTING ON A PRINTED CIRCUIT BOARD

(71) Applicant: ALCATEL-LUCENT CANADA INC., Ottawa (CA)

(72) Inventors: Paul J. BROWN, Wakefield (CA); Alex L. CHAN, Ottawa (CA)

(73) Assignee: ALCATEL-LUCENT CANADA, INC.

(21) Appl. No.: 15/374,483

(22) Filed: Dec. 9, 2016

(51) Int. Cl. G06F 17/50

(52) U.S. Cl. CPC G06F 17/5077

(57) ABSTRACT

A method of laying out electrical connections on a printed circuit board (PCB) including: establishing primary design axes X and Y of the PCB respectively parallel to the weave of the fiberglass fibers in the PCB; selecting a non-zero routing angle θ; defining routing axes X′ and Y′ that are rotated by +θ from axes X and Y; defining routing axes X″ and Y″ that are rotated by −θ from axes X and Y; determining a shortest route between a first point and a second point to be electrically connected, wherein the route traverses a path constrained to extend along the X′, Y′, X″ and Y″ axes.

### TECHNICAL FIELD

Various exemplary embodiments of methods disclosed herein relate generally to routing on printed circuit boards.

### BACKGROUND

Wire routing of printed circuit boards (PCBs) has become more complex as the number of circuit elements on a PCB has increased. As a result computerized auto-routing tools (which may be part of a computer aided design (CAD) system for designing and laying out PCBs) have become widespread as manual layout techniques are too time consuming and costly. X-Y routing may be used to auto-route wires, where all wires follow a path along either an X or Y axis. X-Y routing may be used for complex layout designs that utilize more than two routing layers to contain all of the routing wires. In X-Y routing, the Manhattan length is the shortest path that a wire can have when it must be connected using only segments that are confined to either the X axis or Y axis. The Manhattan length is easily calculated by calculating the difference in the X coordinates of the two endpoints and the difference in the Y coordinates of the two endpoints. The X difference and the Y difference are then added to determine the Manhattan length.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of laying out electrical connections on a printed circuit board (PCB) including: establishing primary design axes X and Y of the PCB respectively parallel to the weave of the fiberglass fibers in the PCB; selecting a non-zero routing angle θ; defining routing axes X′ and Y′ that are rotated by +θ from axes X and Y; defining routing axes X″ and Y″ that are rotated by −θ from axes X and Y; determining a shortest route between a first point and a second point to be electrically connected, wherein the route traverses a path constrained to extend along the X′, Y′, X″ and Y″ axes.

Various further exemplary embodiments relate to a computer aided design (CAD) tool implemented on a computing device for routing electrical connections on a printed circuit board (PCB), including: a memory configured to store instructions; a processor configured to execute the instructions stored on the member, wherein the instructions include: instructions for establishing primary design axes X and Y of the PCB respectively parallel to the weave of the fiberglass fibers in the PCB; instructions for selecting a non-zero routing angle θ; instructions for defining routing axes X′ and Y′ that are rotated by +θ from axes X and Y; instructions for defining routing axes X″ and Y″ that are rotated by −θ from axes X and Y; instructions for determining a shortest route between a first point and a second point to be electrically connected, wherein the route traverses a path constrained to extend along the X′, Y′, X″ and Y″ axes.

Various embodiments are described wherein the routing angle θ is in a range of about 0.5° to about 10°.

Various embodiments are described wherein the routing angle θ is in a range of about 2° to about 6°.

Various embodiments are described wherein the routing angle θ is in a range of about 3° to about 5°.

Various embodiments are described wherein the routing angle θ is about 5°.

Various embodiments are described wherein the routing angle is selected based upon the material composition of the PCB.

Various embodiments are described wherein the routing angle is selected based upon a specified electrical performance of the electrical line connecting the first point and the second point.

Various embodiments are described wherein the routing angle is selected based upon obstacles near the first point and second point and a specified electrical performance of the electrical line connecting the first point and the second point.

Various embodiments are described further including calculating various routes between the first point and second point along the routing axes X′, Y′, X″, and Y″ before determining the shortest route between the first point and the second point.

Various embodiments are described wherein the shortest route is further constrained by the position of obstacles on the PCB.

Various further exemplary embodiments relate to a method of laying out electrical connections on a printed circuit board (PCB) including: establishing primary design axes X and Y of the PCB respectively parallel to the weave of the fiberglass fibers in the PCB; selecting a first non-zero routing angle θ₁; defining routing axes X′ and Y′ that are rotated by +θ₁ from axes X and Y; determining a shortest route between a first point and a second point to be electrically connected, wherein the route traverses a path constrained to extend along the X′ and Y′ axes.

Various embodiments are described further including selecting a second non-zero routing angle θ₂; and defining routing axes X″ and Y″ that are rotated by −θ₂ from axes X and Y, wherein determining a shortest route between a first point and a second point to be electrically connected, further includes wherein the route traverses a path constrained to extend along the X′, Y′, X″ and Y″ axes.

### BRIEF DESCRIPTION OF THE DRAWINGS

In order to better understand various exemplary embodiments, reference is made to the accompanying drawings, wherein:

FIG. 1 illustrates an example of the fiberglass weave of a PCB;

FIG. 2 illustrates two signal lines on a PCB;

FIG. 3 illustrates panel rotation;

FIGS. 4A and 4B show two additional PCB weaves;

FIG. 5 is a plot of skew versus signal line to weave angle for two different weaves;

FIG. 6 shows the alternative axes that may be used to route signal lines with an angle of θ relative to the weave of the PCB;

FIG. 7 shows four alternative routing options between two points;

FIG. 8 shows four alternative routing options between two other points;

FIG. 9 illustrates three different routing situations; and

FIG. 10 is a flow chart illustrating a method for routing signal lines using a routing angle.

It should be understood that the figures are merely schematic and are not drawn to scale. It should also be understood that the same reference numerals are used throughout the figures to indicate the same or similar parts.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or” refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

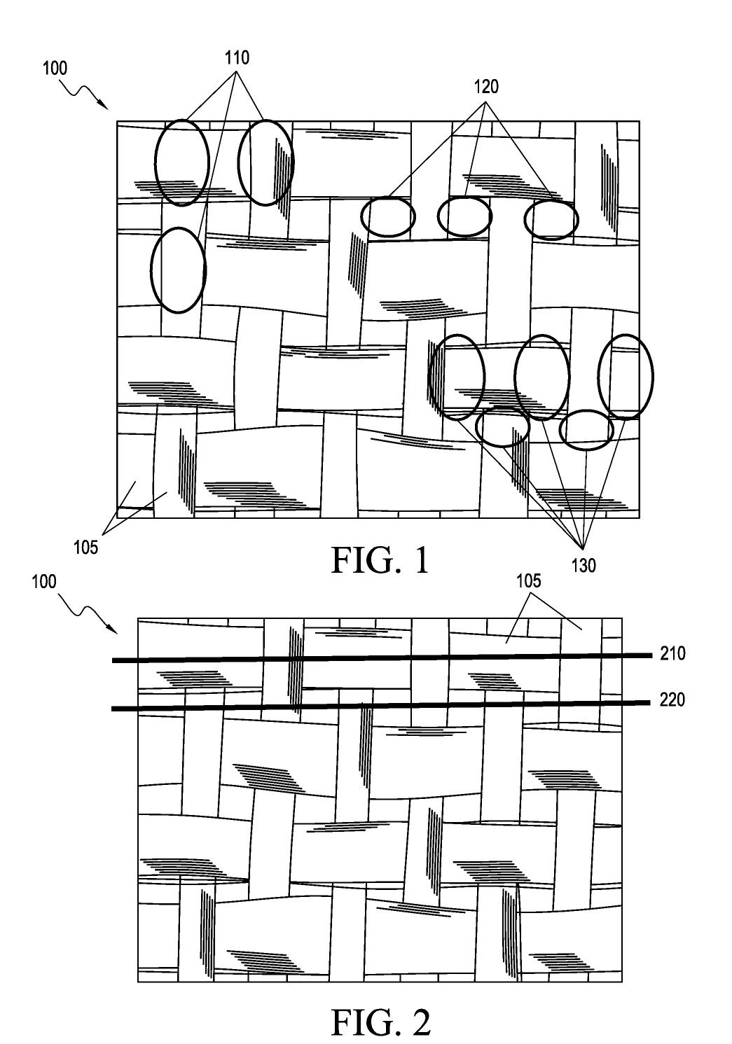

FIG. 1 illustrates an example of the fiberglass weave of a PCB 100. Fiberglass bundles 105 are woven together. The woven fiberglass bundles 105 are then encased in a resin to form the dielectric substrate of the PCB 100. As the signal speeds used on PCBs increase, the heterogeneous nature of the dielectric substrate in the PCB 100 may lead to signal variations that can lead to performance issues. High speed signals running over fiberglass reinforced dielectric materials in a PCB 100 may encounter three different compositional situations/structural having different dielectric characteristics. For example, first areas 110, two fiberglass bundles 105 overlap one another along with a thin layer of resin. In second areas 120, there is only resin and there are no fiberglass bundles 105. In third areas 130, there is only one fiberglass bundle 105 and a thin layer of resin. As a result each of these areas have different dielectric characteristics. As a result, each of these areas will affect a signal on a signal line over these areas differently. As long as these different compositional/structural areas are encountered randomly, their impact on electrical signals is acceptable.

FIG. 2 illustrates two signal lines on a PCB. The two signal lines 210 and 220 are shown running parallel to one another over the PCB 100. Signal line 210 runs over a horizontal fiberglass bundle 105 such that over the length of the signal line 210 it alternates between areas having one horizontal fiberglass bundle and a horizontal and vertical fiberglass bundle. As a result it has a dielectric characteristic that alternates between first and second values. Signal line 220 runs between two horizontal fiberglass bundles 105 such that over the length of the line it alternates between areas having one vertical fiberglass bundle and no fiberglass bundles. As a result, it has a dielectric characteristic that alternates between third and fourth values. Therefore, signal lines 210 and 220 have different effective dielectric characteristics, and orthogonal routing practices and the orthogonal nature of fiber weaving are such that high speed signals on different routes may experience very different dielectric characteristics depending on its location and orientation. This creates noticeable signal integrity and timing problems. This has become known as the “weave effect.” Differential lines are especially sensitive to such weave effects.

In recognition of the weave effect, the industry has pursued three different approaches for addressing the weave effect. The first is spread glass. In spread glass, the fiberglass fibers are spread out so that the resulting material becomes somewhat more homogeneous, thus reducing the weave effect. A drawback of this solution are that it does not completely eliminate the issue, but rather just lessens the weave effect. Cost and availability are other issues with this approach.

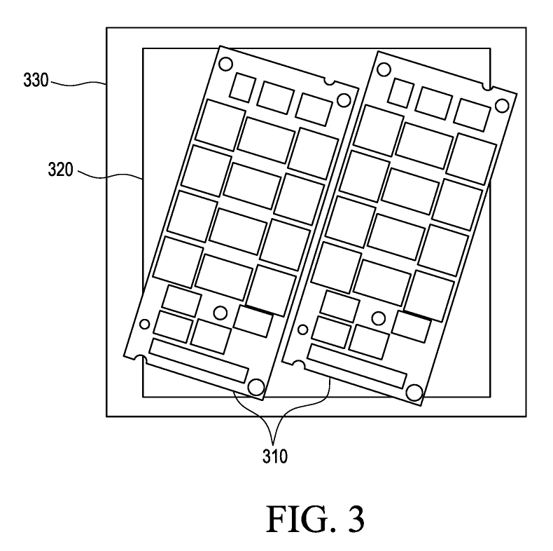

The second approach is panel rotation. FIG. 3 illustrates panel rotation. Two finished PCBs 310 are shown rotated. The two finished PCBs 310 may be fabricated from a PCB panel 330. If the two finished PCBs 310 were not rotated they could be fabricated from a PCB panel 320. As can be seen the PCB panel 330 is larger than PCB panel 320. By rotating the finished PCBs 310 by a non-orthogonal angle relative to the layout of the devices on the PCB, the orthogonally routed signal lines that are later superimposed on the finished PCBs 310 will not have the variations in dielectric characteristics as described above, because any orthogonally routed signal lines will encounter random variations in the dielectric characteristics along their lengths, so that the overall dielectric conditions will not be dependent upon trace location or orientation. That is for any given signal line the dielectric effects will average out so that the variations between signal lines will be greatly reduced. Drawbacks of this approach include the waste that results from cutting a rectilinear board from a rotated panel and by extension increased cost, and the requirement for machinery to handle the wider panel 330.

The third approach is to use non-reinforced dielectric materials for the PCB by doing away with the fiberglass reinforcement, thereby only using a resin layer which is much more homogeneous. This approach would certainly address the dielectric characteristics variations, but this approach introduces a whole set of other quality and reliability issues related to the removal of the fiberglass reinforcement.

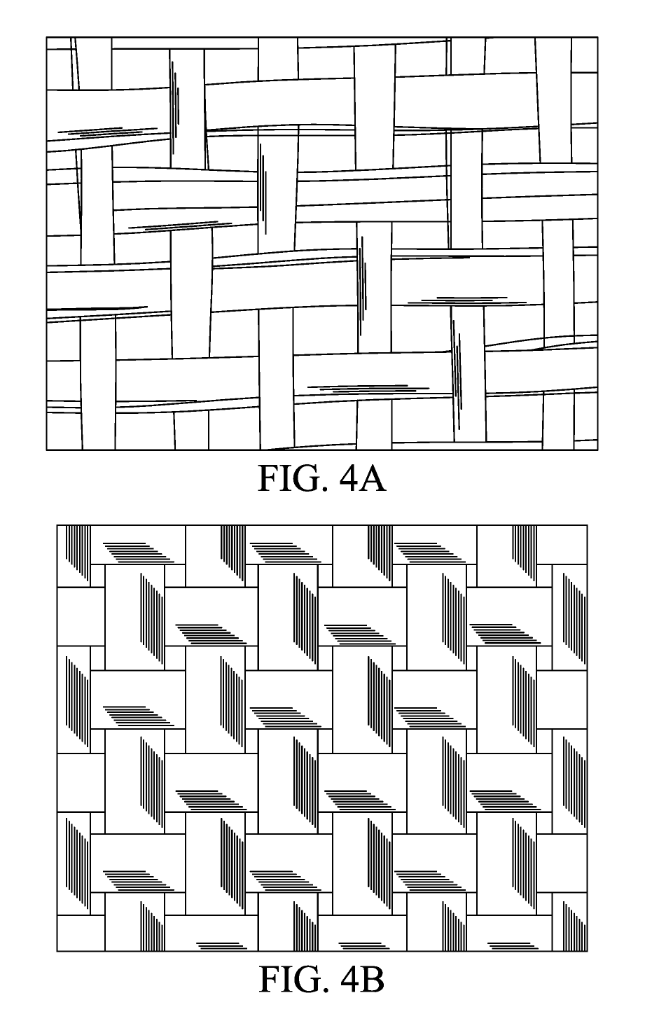

FIGS. 4A and 4B show two additional PCB weaves. In FIG. 4A the weave is less dense, i.e., there are large openings where there is no fiberglass that are filled with resin. In FIG. 4B the weave is more dense, i.e., there are only small opening where there is no fiberglass that are filled with resin. Each of the different PCB weaves of FIGS. 2, 4A, and 4B will have different dielectric characteristics that may be quite different. As a result the specific material composition of the PCB can lead to large variations in dielectric characteristics for different types of PCBs.

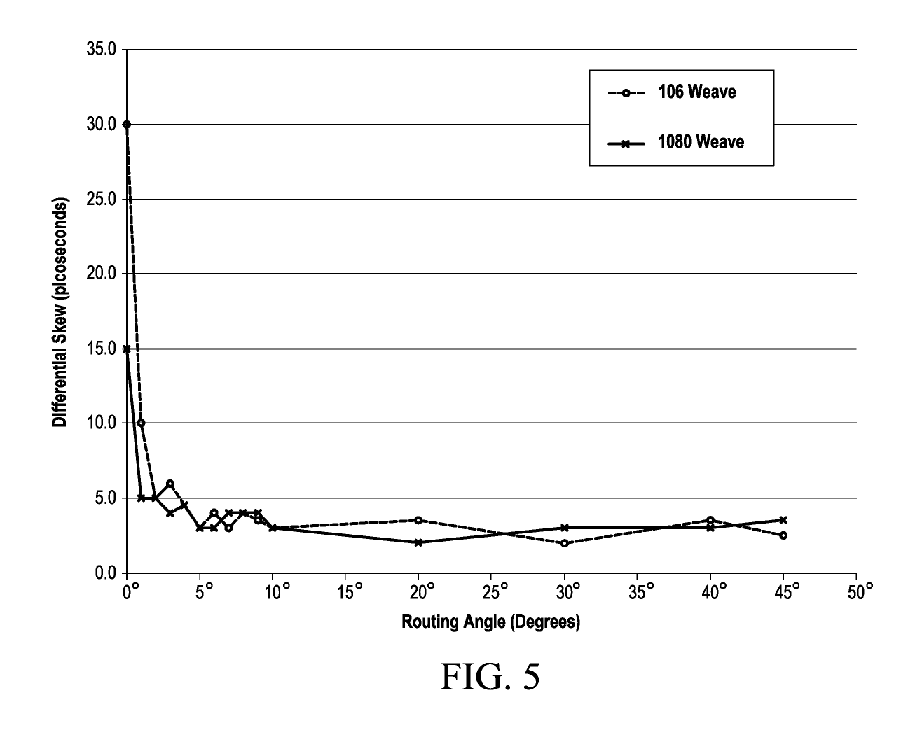

As discussed above, a solution to overcome the variations in dielectric characteristics of the PCB, is to route signal lines at angle to the fiberglass weave, which may be called the routing angle. Measurements were made of the skew induced on differential signal lines for different routing angles. These measurements were made by patterning parallel sets of traces on a panel, with each set of traces being rotated slightly relative to the panel's primary axis (which coincides with the fiber routing directions). The trace ends were terminated with the appropriate high frequency SMA connectors, such that a signal could be inserted on the near and of each pair and the resulting transmission measured on the far end. By contrasting the arriving signals on the far end, skew resulting from variations in the dielectric media could be measured. FIG. 5 is a plot of differential skew versus routing angle for two different weaves. As can be seen at 0° the skew is 15 ps and 30 ps. At 2° the skew has dropped to 5 ps. At about 5° the skew drops to about 3 ps. For greater routing angles, the skew value varies between about 2 ps and 4 ps. As seen in FIG. 5, the skew performance improves with even small routing angles as low as 2°. At 5° the skew reaches a level that is acceptable for many applications. As a result, if the signal lines are implemented with a routing angle, the skew performance on those signal lines may be improved. Routing angle values of about 0.5° to 10° provide improvement over a 0° angle. Further, various routing angle values such as 2°, 3°, 5°, and 10° provide improvement over a 0° routing angle. Routing angles in various ranges such as 0.5° to 10°, 2° to 5°, 2° to 6°, 3° to 6°, 3° to 7°, and 5° to 10° provide improvement over a 0° angle.

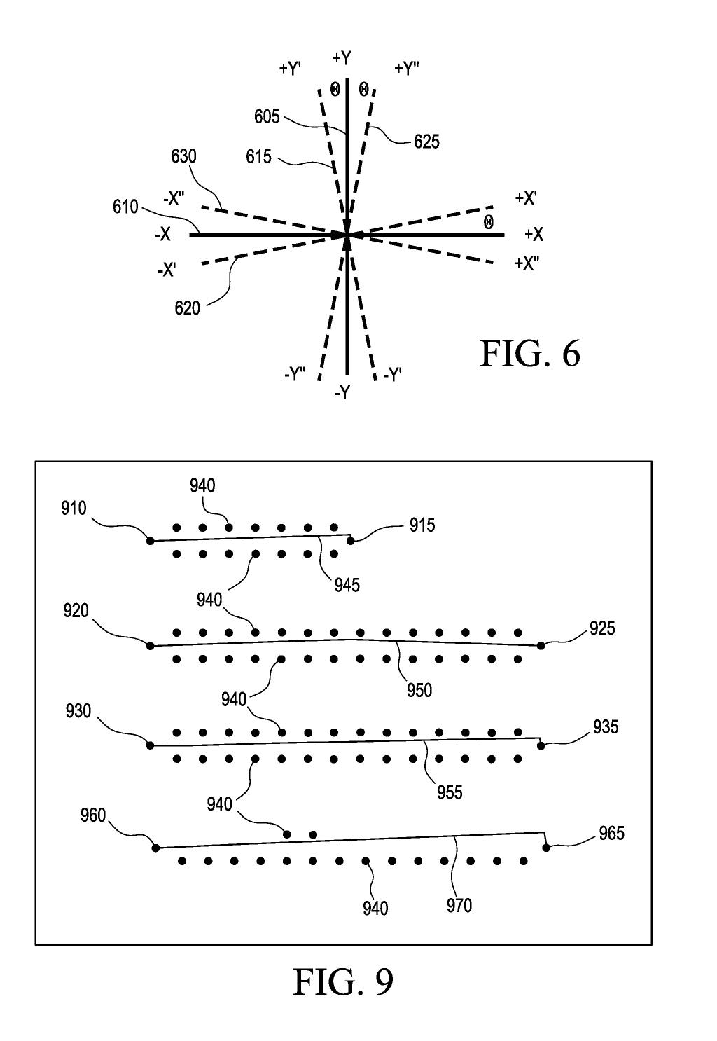

FIG. 6 shows the alternative axes that may be used to route signal lines with an angle of θ relative to the weave of the PCB. The X axis 610 and the Y axis 605 are aligned with the fiberglass weave of the PCB. The X′ axis 620 and the Y′ axis 615 are rotated +0° from the X axis 610 and the Y axis 605. The X″ axis 630 and the Y″ axis 625 are rotated −0° from the X axis 610 and the Y axis 605. X′ axis 620, Y′ axis 615, X″ axis 630, and Y″ 625 define directions that signal lines may be routed. In other embodiments, the magnitude of the rotation angles of the X′ axis 620 and the Y′ axis 615 and the X″ axis 630 and the Y″ axis 625 may be different, e.g., +3° and −4° respectively. In yet another embodiment, the “X” axes and the “Y” axes may have different amounts of rotation, e.g., ±3° and ±4° respectively. This would result the alternative “X” and “Y” axes being slightly non-orthogonal. In another embodiment there may only be a single rotation using the X′ axis and the Y′ axis for routing. In another embodiment only a single axis may be rotated, i.e., only one of the X′ axis or the Y′ axis are rotated for routing.

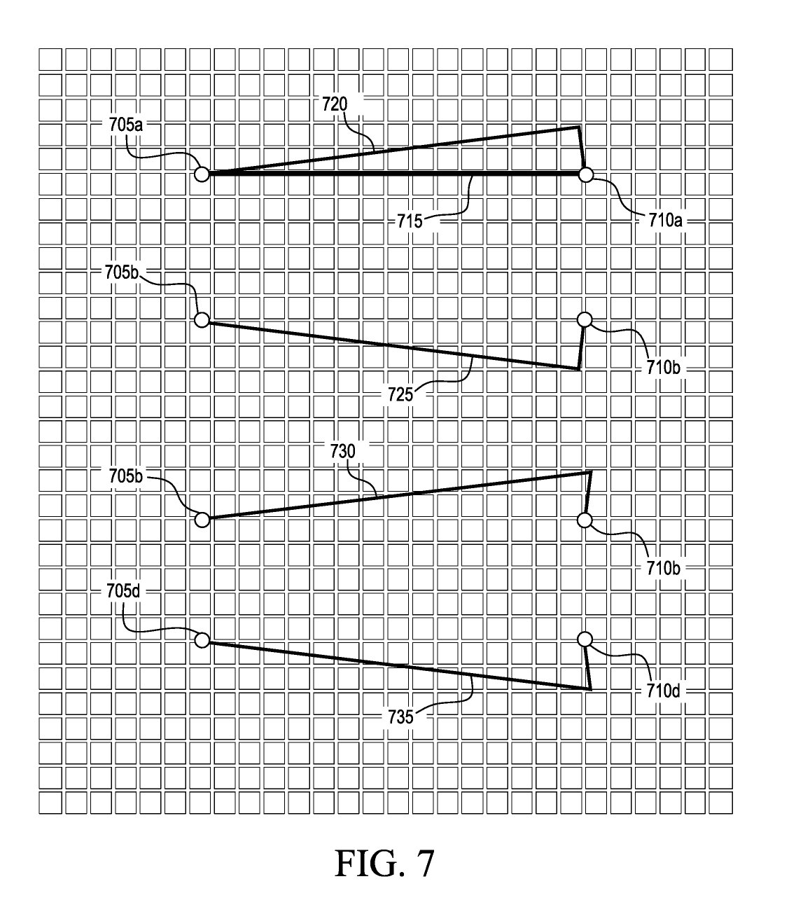

FIG. 7 shows four alternative routing options between two point's endpoints 705a-d, and 710a-d. A first point 705a and a second point 710a on a PCB would typically be connected by a signal line along a route 715 using orthogonal routing. A first alternate route 720 has a first portion in the +X′ direction and a second portion in the −Y′ direction. A second alternate route 725 has a first portion in the +X″ direction and a second portion in the +Y″ direction. A third alternate route 730 has a first portion in the +X′ direction and a second portion in the −Y″ direction. A fourth alternate route 735 has a first portion in the +X″ direction and a second portion in the +Y′ direction. It is noted that four additional alternate routes are possible if the route first traverses generally in the “Y” direction followed by generally in the “X” direction. These four additional routes would be mirror images of the four alternate routes 720, 725, 730, and 735. In this particular example θ is 7°, but other values may also be used.

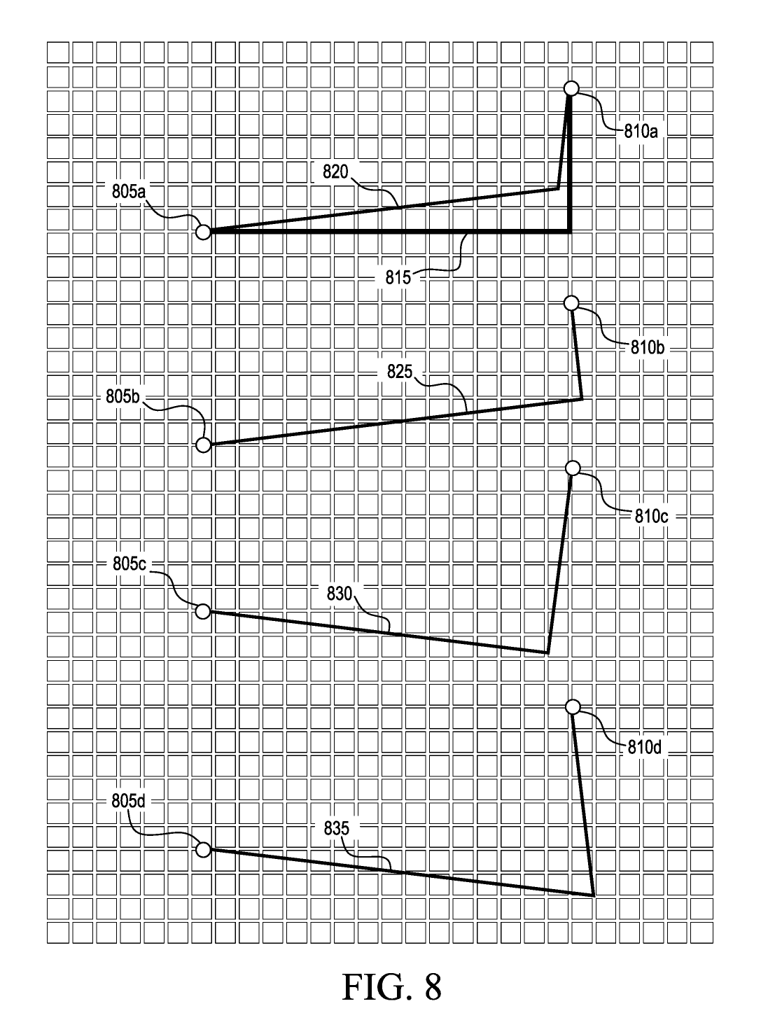

FIG. 8 shows four alternative routing options between two other points' 805a-d, and 810a-d. A first point 805a and a second point 810a on a PCB would typically be connected by a signal line along a route 815 using orthogonal routing. The route 815 proceeds in both the +X and the +Y direction. The four alternate routes 820, 825, 830, and 835 first proceed generally in the “X” direction and then generally in the “Y” direction. Further, four additional alternate routes are possible if the route first traverses generally in the “Y” direction followed by generally in the “X” direction. These four routes would be mirror images of the four alternate routes 820, 825, 830, and 835. These four additional routes would be mirror images of the four alternate routes 720, 725, 730, and 735. In this particular example θ is 7°, but other values may also be used.

FIG. 9 illustrates four different routing situations. In a first routing situation two pads 910 and 915 are connected by a signal line 945. In the first routing situation a plurality of obstacles extend between the two pads 910 and 915. These obstacles 940 form a corridor that the signal line passes through. These obstacles may be vias, pads, signal lines, components, etc. that limit where the signal line 945 may be placed on the PCB. The size and shape of the corridor is defined by the obstacles and the minimum distance that a signal line may be placed relative to an obstacle. The routing angle for the first routing situation is θ₁, which is chosen to provide acceptable skew and other performance. The signal line 945 first follows a path in the +X′ direction that is rotated by θ₁ from the +X direction. Next, the signal line 945 follows a path in the −Y′ direction that is rotated by θ₁ from the −Y direction. In this situation the corridor is wide enough that the signal path 945 is able to traverse the length of the corridor inside the corridor.

In a second routing situation two pads 920 and 925 are connected by a signal line 950. The distance between the two pads 920 and 925 is large enough that signal line 950 zig-zags to connect the two pads 920 and 925 in order to remain inside the corridor. If the distance between two pads to be connected is even greater, then the signal line may zig-zag multiple times in order to remain within the corridor and to connect two pads. The need to zig-zag and the number of zig-zags depends upon the width of the corridor to be traversed, the distance between the two points to be connected, and the routing angle.

In a third routing situation two pads 930 and 935 are connected by a signal line 955. In this situation a routing angle θ₂ that is less than the routing angle θ₁ in the second situation may be chosen. As a result, the signal line 955 does not need to zig-zag like the signal line 950 in the second situation. This may lead to a signal line 955 that provides less interference to other signal lines than the signal line 945. If the skew and other performance characteristics for the routing angle θ₂ are acceptable, then the signal line 955 may be routed using the routing angle θ₂.

In a fourth routing situation two pads 960 and 965 are connected by a signal line 970. In the situations described above the corridors were well defined on both sides forming a well-defined straight corridor that the signal line may traverse. In the fourth situation the corridor is not as constrained as there are only two obstacles on one side of the signal line 970 about midway down the signal line 970. In this situation, a routing angle θ₃ that is greater than the routing angle θ₂ in the second situation may be chosen. As a result, the signal line 955 does not need to zig-zag like the signal line 950 in the second situation and as the angle θ₃ that is greater than the routing angle θ₂ of the third situation the skew performance will be better. The routing angle θ₃ may be less than or equal to θ₁. If the skew and other performance characteristics for the routing angle θ₃ is acceptable, then the signal line 970 may be routed using the routing angle θ₃ to avoid a zig-zag in the line.

The routing angle may be chosen in a variety of different ways. In one embodiment, the routing angle may be chosen to be a fixed value used throughout the whole PCB. This routing angle is chosen to provide acceptable skew and other performance for the various signal lines on the PCB. The maximum length signal line required on the PCB will result in the maximum skew and hence affect the selection of the routing angle.

As the various situations above illustrate, the routing angle may be varied based upon the points to be connected and the obstacles between the points to be connected. In other embodiments, the routing angle may be selected to avoid obstacles and to achieve a desired skew and other performance.

As a result various approaches for selecting the routing angle may be implemented. As mentioned above a fixed routing angle for the whole PCB is possible. Another possibility is to use a range for routing angles that will provide acceptable skew and other performance. Another approach is to only route those signal lines at a routing angle that are sensitive to the dielectric variations of the PCB board. The signal lines that are not sensitive to the dielectric variations of the PCB board my use traditional orthogonal style routing long axes followed by the fiberglass weave. Another approach is to generally use a fixed routing angle where possible, and then vary the routing angle for signal lines that have obstacles that would cause the signal line to zig-zag and where zig-zag is undesirable and then the routing angle is selected to meet a specified skew and other performance of the signal line. Further, the routing angle may be selected for each signal line to be routed based upon the parameters associated with the signal line, the desired skew and other performance, and the obstacles on the PCB.

It is further noted as mentioned above that different routing angles may be used in the “X” and the “Y” directions to avoid obstacles. For example, the signal lines 945, 950, and 970 have short portions that extend in the “Y” direction. If this length is below a certain threshold, it is possible that this short portion may be routed along the axes of the fiberglass weave.

As shown in FIG. 5, using even small routing angles may provide a great improvement in the skew performance of a signal line. As a result routing angles may be used when routing signal lines in order to improve skew and other performance of the signal lines. Various approaches for using routing angles are discussed above and others may be used. The selection of the routing angle may depend upon the specific PCB material and the characteristics of the signals to be routed along the signal line. As a result, a CAD system used to layout a PCB with signal lines using a routing angle may include information relating to the performance characteristics of the PCB. For example, a look up table that includes the performance of the PCB for various routing angles may be used to select the desired routing angle. Such data may be stored for various types of PCBs that may be used. Also, the signal performance for the various signals routed on the board may be stored and used for signal line routing. Also, an overall performance for all of the signals on the PCB may be used for all of the signal lines on the board.

As a result the CAD system used to layout a PCB may implement one or many of the routing approaches described above. It might use a single fixed routing angle for all of the signal lines or it may vary the routing angle for each signal line as needed. A user of the CAD system may input information needed to route the signal lines on the PCB, such a routing angle to use, performance requirements for the board as a whole or by signal, and the type of material of the PCB or the performance characteristics of the PCB. The CAD system may have a catalog of performance data for various PCBs so that the PCB designer may input a selection of the specific PCB type being used. The CAD system may take into account the signal characteristics, materials used, geometries, manufacturing processes available, various performance requirements, etc. when performing the signal line routing. The CAD system may allow the PCB designer to control various aspects of the approach taken in routing the signal lines.

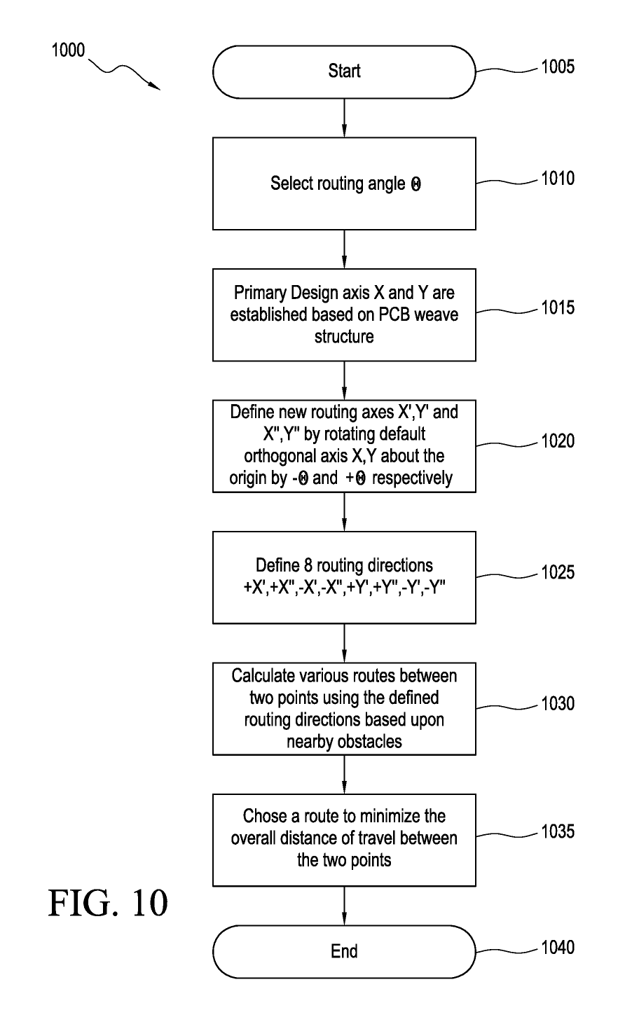

FIG. 10 is a flow chart illustrating a method for routing signal lines using a routing angle. The method 1000 may be implemented by a CAD system used to design PCBs. The method 1000 may start at 1005 and proceed to step 1010 where the routing angle is selected. The routing angle may be selected using any of the methods described above. Next, at step 1015, the primary design axes X and Y are selected based upon the PCB weave structure. At step 1020 the method 1000 defines new routing axes X′, Y′ and X″, Y″ by rotating default orthogonal axis X, Y about the origin by −θ and +θ respectively. These new routing axes define the directions that the route may take. It is further noted as described above that in some situations the routing angle for the “X” and “Y” axes may be selected to be different so the “X” and “Y” axes may be rotated by different amounts. Next, at step 1025 the method 1000 defines 8 routing directions +X′, +X″, −X′, −X″, +Y′, +Y″, −Y′, and −Y″. These are the directions that may be used to route signal lines. This would apply to either auto routing by a CAD system or manual routing by a user of the CAD system. At step 1030, the method calculates various routes between two points using the defined routing directions based upon nearby obstacles. This may be done as illustrated in FIG. 7-9 above. At this step, the routes may be adjusted by changing the routing angle as described above to avoid obstacles and to reduce the amount of zig-zag. At step 1035 the method chooses a route to minimize the overall distance of travel between the two points. The method 1000 then ends at 1040. Steps 1020 to 1035 may be repeated for each signal line on the PCB. Further, in embodiments where each signal line may have its own routing angle, steps 1010 to 1035 may be repeated for each signal line on the PCB.

The CAD system may include any Electronic Design Automation tool or technique. For example, mask data preparation (MDP) may be used such as generation of lithography photomasking which may be used to manufacture a circuit or chip. Resolution enhancement techniques to increase the photomask quality may also be used. Similarly, Optimal Proximity Correction (OPC) for compensation of interference and diffraction may be utilized. Mask generation may also be utilized in the manufacturing. Software systems and versions such as Advanced Design System, Altium Designer, CircuitLogix, CircuitMaker, DesignSpark PCB, Pulsonix, SLED and Micro-Cap may be used or programmed for creation and automation of such circuits. The CAD system may implement the routing methods described above in order to improve the electrical performance of signal lines due to the weave effect.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of laying out electrical connections on a printed circuit board (PCB) comprising:
establishing primary design axes X and Y of the PCB respectively parallel to the weave of the fiberglass fibers in the PCB;
selecting a non-zero routing angle θ;
defining routing axes X′ and Y′ that are rotated by +θ from axes X and Y;
defining routing axes X″ and Y″ that are rotated by −θ from axes X and Y;
determining a shortest route between a first point and a second point to be electrically connected, wherein the route traverses a path constrained to extend along the X′, Y′, X″ and Y″ axes.

2. The method of claim 1, wherein the routing angle θ is in a range of about 0.5° to about 10°.

3. The method of claim 1, wherein the routing angle θ is in a range of about 2° to about 6°.

4. The method of claim 1, wherein the routing angle θ is in a range of about 3° to about 5°.

5. The method of claim 1, wherein the routing angle θ is about 5°.

6. The method of claim 1, wherein the routing angle is selected based upon the material composition of the PCB.

7. The method of claim 1, wherein the routing angle is selected based upon a specified electrical performance of the electrical line connecting the first point and the second point.

8. The method of claim 1, wherein the routing angle is selected based upon obstacles near the first point and second point and a specified electrical performance of the electrical line connecting the first point and the second point.

9. The method of claim 1, further comprising calculating various routes between the first point and second point along the routing axes X′, Y′, X″, and Y″ before determining the shortest route between the first point and the second point.

10. The method of claim 1, wherein the shortest route is further constrained by the position of obstacles on the PCB.

11. A method of laying out electrical connections on a printed circuit board (PCB) comprising:
establishing primary design axes X and Y of the PCB respectively parallel to the weave of the fiberglass fibers in the PCB;
selecting a first non-zero routing angle θ₁;
defining routing axes X′ and Y′ that are rotated by +θ₁ from axes X and Y;
determining a shortest route between a first point and a second point to be electrically connected, wherein the route traverses a path constrained to extend along the X′ and Y′ axes.

12. The method of claim 11, wherein the routing angle θ₁ is in a range of about 0.5° to about 10°.

13. The method of claim 11, wherein the routing angle θ₁ is in a range of about 2° to about 6°.

14. The method of claim 11, wherein the routing angle θ₁ is in a range of about 3° to about 5°.

15. The method of claim 11, further comprising:
selecting a second non-zero routing angle θ₂; and
defining routing axes X″ and Y″ that are rotated by −θ₂ from axes X and Y,
wherein determining a shortest route between a first point and a second point to be electrically connected, further includes wherein the route traverses a path constrained to extend along the X′, Y′, X″ and Y″ axes.

16. A computer aided design (CAD) tool implemented on a computing device for routing electrical connections on a printed circuit board (PCB), comprising:
a memory configured to store instructions;
a processor configured to execute the instructions stored on the member, wherein the instructions include:
instructions for establishing primary design axes X and Y of the PCB respectively parallel to the weave of the fiberglass fibers in the PCB;
instructions for selecting a non-zero routing angle θ;
instructions for defining routing axes X′ and Y′ that are rotated by +θ from axes X and Y;
instructions for defining routing axes X″ and Y″ that are rotated by −θ from axes X and Y;
instructions for determining a shortest route between a first point and a second point to be electrically connected, wherein the route traverses a path constrained to extend along the X′, Y′, X″ and Y″ axes.

17. The CAD tool of claim 17, wherein the routing angle θ is in a range of about 0.5° to about 10°.

18. The CAD tool of claim 17, wherein the routing angle θ is in a range of about 2° to about 6°.

19. The CAD tool of claim 17, wherein the routing angle θ is in a range of about 3° to about 5°.

20. The CAD tool of claim 17, wherein the instructions further comprise calculating various routes between the first point and second point along the routing axes X′, Y′, X″, and Y″ before determining the shortest route between the first point and the second point.
